(19) United States
(12) Patent Application Publication
(10) Pub. No.: US 2014/0253483 A1
(43) Pub. Date: Sep. 11, 2014

(54) Wall-Mounted Multi-Touch Electronic Lighting- Control Device with Capability to Control Additional Networked Devices

(71) Applicant: UBE Inc. dba Plum, Austin, TX (US)

(72) Inventors: Daniel J. Kupersztoch, Austin, TX (US); Glen A. Burchers, Round Rock, TX (US); Utz D. Baldwin, Austin, TX (US)

(73) Assignee: UBE Inc. dba Plum, Austin, TX (US)

(21) Appl. No.: 14/198,279

(22) Filed: Mar. 5, 2014

Related U.S. Application Data
(60) Provisional application No. 61/773,896, filed on Mar. 7, 2013.

(51) Int. Cl. G06F 3/01

(52) U.S. Cl. CPC G06F 3/017
USPC 345/173

(57) ABSTRACT

An in-wall, touch-actuated electronic control device makes use of gesture motions. A touch sensor permits a user to input control commands through the use of one or more one- or two-dimensional gestures such as one- or two-fingered tapping; swiping; tracing; pinching; and zooming, allowing for a significant increase in the potential number of network endpoints that can be controlled from, and also in the number of control signals that can be generated by, a single touch-control device. The touch-control device may include both a direct load controller such as a light switch or dimmer as well as a network connection to allow control of networked devices, either on a local network (for example a home WiFi network) or, for example, Web applications hosted on a remote server.

### INCORPORATION BY REFERENCE

This application claims the benefit of, and incorporates by reference, the commonly-owned provisional patent application Ser. No. 61/773,896, filed Mar. 7, 2013, entitled “Electronic device utilizing touch control gestures to control itself and other devices,” by the inventors of this application.

### 1. BACKGROUND OF THE INVENTION

### Capitalized Terms

For convenient reference, some instances of particular terms in the body of various paragraphs below and in the claims are presented in all-capital letters. This serves as a reminder that the all-caps terms are explained in more detail in the Glossary below and/or elsewhere in the description below. Not all instances of an all-caps term are necessarily presented in all-capital letters, though; that fact should not be interpreted as indicating that such other instances have a different meaning.

Our invention relates generally to electronic control devices installable in walls. Such control devices are typically used to control connected electrical loads such as lights, fans, and the like; such control devices conventionally have used buttons to actuate them.

Control devices within single- or multiple-gang electrical boxes have evolved in recent years. Simple control devices (for example, conventional light switches) control only local loads that are connected to the control devices via existing wiring. Some control devices allow for a single load to be controlled from multiple locations, e.g., two simple light switches mounted at different places in a room or elsewhere in a house can each switch a light on or off.

Other control devices use buttons or other features to control a local load in different ways. For example, load controllers that allow dimming of a light often have hard buttons, slides, or rotating knobs that can be pushed, slid, or twisted, thereby causing the light to brighten or dim. As another example, some timer devices allow the user to push one of four or five physical buttons to turn on the timer, and then the timer will automatically shut off. And as still another example, motion-based control devices can automatically turn a load, such as a light, on or off in conjunction with detecting motion or the absence of it.

Some control devices, located within a wall switch, can be used to control other devices within a home. These control devices usually control the local load but it is not required. Such control devices typically use a fixed number of buttons to allow for control signals to be sent via connected wires or via a network using a control protocol (in essence, a common language “spoken” by both the control device and the controlled device). Some control devices allow for alternate signals to be sent if a button is pushed in different manners, for example a single tap, rapid double tap, or press-and-hold.

### 2. SUMMARY OF THE INVENTION

Our invention relates to an in-wall, touch-actuated electronic control device that makes use of gesture motions on a touch-pad sensor on which a user can input control commands through the use of one- or two-dimensional gestures such as tapping; one- or two-fingered swiping; tracing; pinching; and zooming, together allowing for a significant increase in the potential number of network endpoints that can be controlled from, and also in the number of control signals that can be generated by, a single touch-control device. Our touch-control device may include both one or more direct load controllers such as an on-off light switch or dimmer switch as well as a network connection to allow control of networked devices, either on a local network (for example a home WiFi network) or a wider network such as the Internet, including for example Web applications hosted on a remote server.

### 3. BRIEF DESCRIPTION OF THE DRAWINGS

FIG. 1 is a perspective view showing a wall-installable touch-control device 100 in accordance with the invention; the illustrated control device fits and can be installed within a single-gang wall box 110 and can be covered by a conventional single-gang wall plate 105, but of course other configurations are possible.

FIG. 2 is a block diagram of major components within the touch-control device 100.

FIG. 3 shows examples of gestures that can be used on the control device.

FIG. 4 shows examples of traced characters that can be used as gesture inputs on the control device. Examples include lower case letters, upper case letters, numbers, and symbols.

FIG. 5 shows examples of multi-stroke character gestures and custom single- and multi-touch gestures. Additionally, an example of relative size of gestures is depicted to show how similar gestures of different size may be identified by the electronic device as two gestures.

FIG. 6 shows an example of how gestures made in different regions of the control device may be identified by the device as different gestures.

FIG. 7 is a flow chart illustrating a basic approach to identifying a gesture made on the control device.

FIG. 8A and FIG. 8B are flow charts showing different basic methods of learning gestures based on input by a user operating a touch-control device in accordance with the invention and operating a networked endpoint.

For the avoidance of doubt, the written legends shown in some of the drawing figures are for purposes of illustration only and are not intended to limit the scope of the claims.

### 4. DETAILED DESCRIPTION OF SPECIFIC EMBODIMENTS

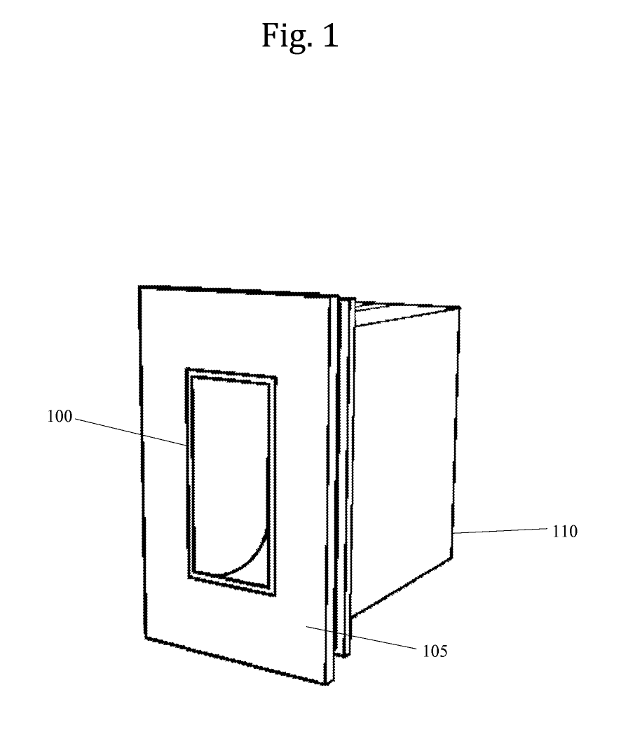

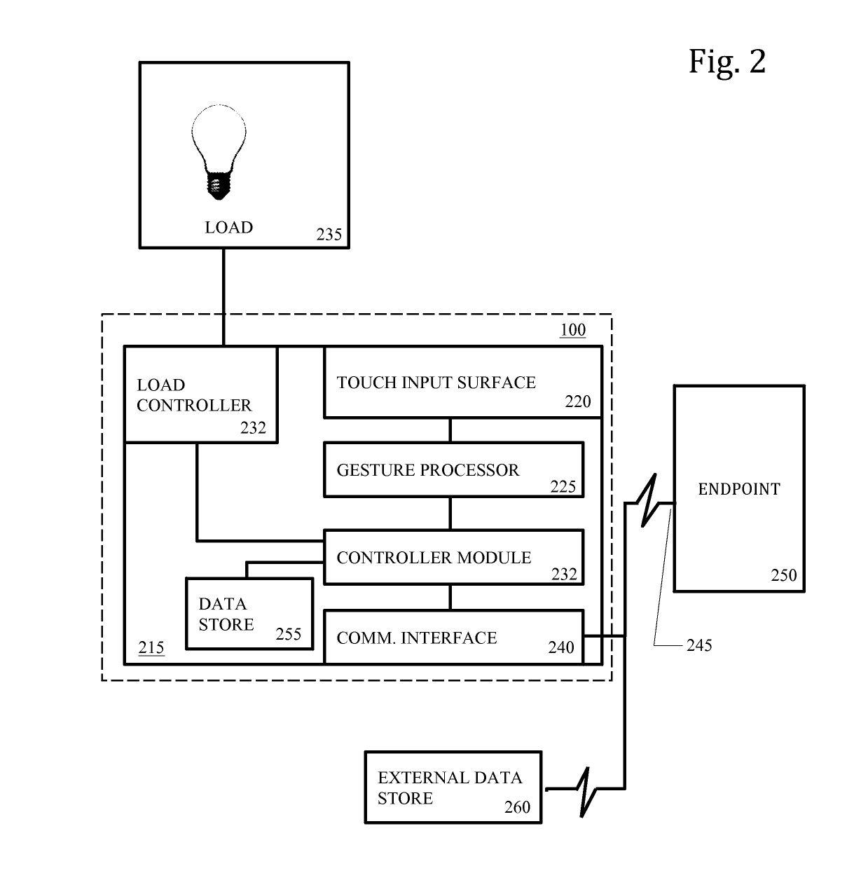

OVERVIEW: Referring to FIG. 1 and FIG. 2, our invention relates to a touch-control device 100 for controlling one or more local loads 235 and, optionally, one or more network-endpoint devices (referred to simply as “endpoints”) 250, each described in more detail below.

### 4.1. Components

The touch-control device 100 is configured to fit within a standard electrical-type wall box 110 such as, for example, the Carlon R-118 single-gang electrical box. (The “standard” box may vary in different countries or regions, of course, for example the U.S.; the European Union; and the Asia-Pacific region.) In some applications a double-gang box may be preferred for its greater available space.

The touch-control device 100 includes a touch-panel assembly 215 that includes a capacitive touch-input surface 220 capable of detecting gestures in two dimensions, such as seen in many smart phones and tablet computers. A resistive or surface acoustical wave (SAW) touch-input surface can also be used.

A variety of touch-panel assemblies are commercially available; the selection of a particular one and the exact details of the implementation using the selected one are design choices for the implementer.

The touch-panel assembly 215 is preferably of a multi-touch design to allow for a richer set of gestures on the part of the user, as will be familiar to users of some smart phones and tablet computers. There are multiple ways of doing multi-touch, such as (for example) iridium trioxide (ITO). Single-touch designs will also be suitable for many implementations, as will be seen in the discussion below.

We have found that satisfactory results can be obtained by using the commercially-available Cypress CY8CTST242, a multi-touch capacitive touchscreen capable of receiving two-finger functionality including pinch and zoom gestures.

When a user makes a gesture on the touch-input surface 220, a gesture processor 225 generates an electrical-signal representation of the gesture. In some commercial touch-panel assemblies, such a gesture processor is built-in, or is a separate component that is packaged with the touch-panel assembly's other components. Other commercial touch-panel assemblies can be obtained without such gesture processors; in that case, the touch-panel assembly must be adapted to a separately-obtained gesture processor.

The signals generated by the gesture processor 225 are sent to a controller module 230, which may include a microprocessor (for example an ARM-9 or 8086 microprocessor) running an operating system or a microcontroller (for example a PSOC-4 or M3 microcontroller) running a real-time operating system (RTOS), with suitable programming to perform the operations described below. Such programming is well within the realm of ordinary skill and therefore is not described here in detail.

Typically, a capacitive touch-panel assembly will come bundled with a controller module; for cost-saving purposes it may well be desirable to use the bundled controller module.

The gesture processor 225 may be coupled to the controller module 230 in any desired manner, for example via a standard communication configuration such as a serial device over a UART, an I2C bus structure, SPI, or the like.

The touch-control device 100 includes one or more LOAD CONTROLLERS 232, each designed to be directly connected to control the application of power to one or more local load 235, such as one or more light fixtures or ceiling fans, installed on the electrical-power circuit from which the load 235 draws its power. (This is conventionally referred to as having the local load or loads 235 installed on the same switch leg as the control device.) This is typically accomplished by the use of a relay or a variable-power controller. The power-controlling capability of any given load controller 232 may be binary, as in a simple “on” and “off” switch; or effectively variable, for example in the form of a dimmer switch; or discrete, for example as with a multi-speed fan controller that has low, medium, and high speeds.

The touch-control device 100 may also include a COMMUNICATION INTERFACE 240 that, in operation, conventionally sends and receives packet-based signals, via a NETWORK 245, to control at least one networked ENDPOINT 250, such as (to use one example) a SONOS® wireless music system. An endpoint 250 may also take the form of other “smart” devices such as wall-installed electrical outlets, ceiling-mounted recessed lighting cans, and the like.

The communication protocol used by the communication interface 240 will vary with the network 245 and the endpoint 250; typical examples include TCP/IP; UDP; Zigbee; ZWave; and/or proprietary protocols.

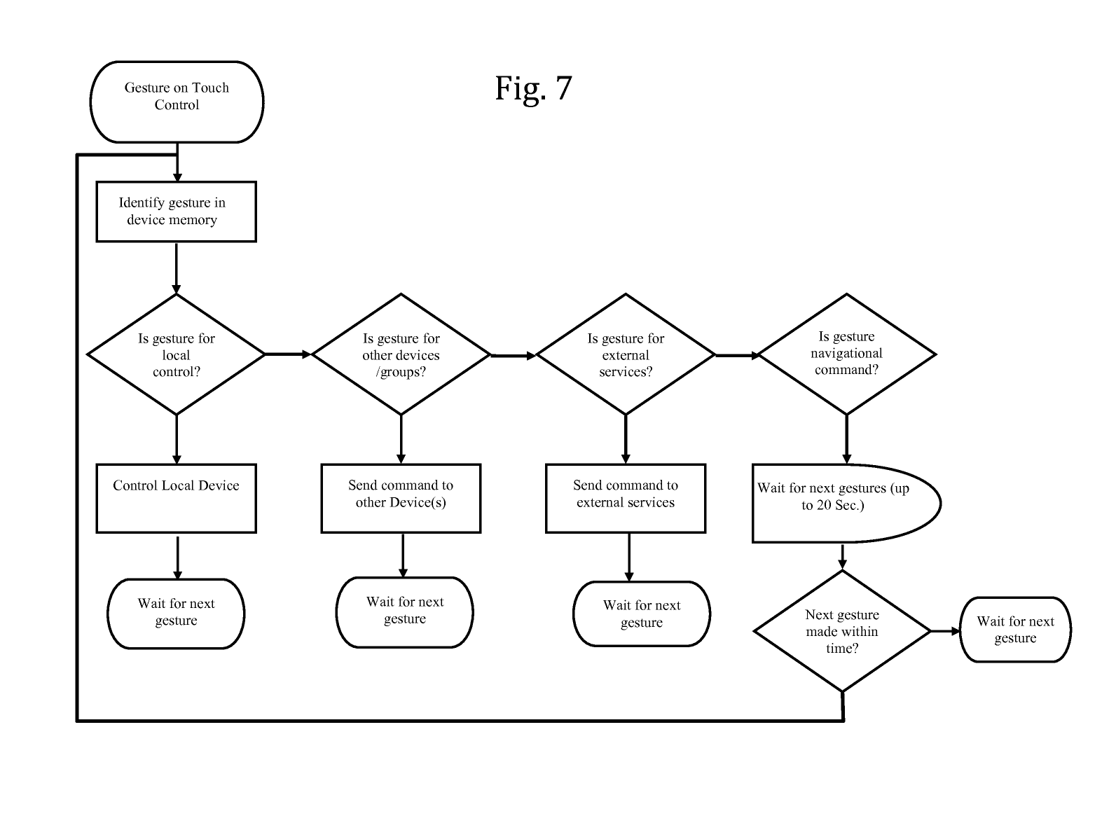

OPERATION: Other parts of the touch-control device 100 will now be described by reference to the operation of the control device as illustrated in the flow chart in FIG. 7. A user makes a gesture on the touch-input surface 220. (Examples of specific gesture types are discussed below.) The gesture processor 225 “reads” the gesture from the touch-input surface 220 and sends a digital signal representing the gesture (referred to as the “gesture signal”) to the controller module 230.

The controller module 230 attempts to match the gesture signal with a known gesture, for example by looking it up in one or more DATA STORES 255 containing a library of known gestures. A data store may take any convenient form, for example flash memory. The library may be pre-configured, user-configured, or both. The library of known gestures may be stored or coded in the data store or data stores 255 in any convenient manner; some gestures might be stored as simple bit-map patterns, others as arrays, of vectors, and so on.

A data store 255 may be local to the touch-control device 100; in addition or alternatively, in some implementations—for example, if unit manufacturing cost is a concern—an external data store 260 might be “in the cloud” or on another network device, for example as part of a different touch-control device 100. This would allow for some touch-control devices 100 to be comparatively “smart” and others less so, configured in a host-and-peripheral arrangement.

If the controller module 230 successfully matches the gesture signal with a known gesture in a data store 255, then the controller module takes the actions indicated by the gesture. For example, the controller module might actuate a load controller 232, for example to switch a light on or off or to dim or brighten it. The controller module might also send a signal, via the communications interface 240, to actuate a networked endpoint 250, for example switching channels on a networked television; changing the volume on a networked stereo; turning on a networked lawn-sprinkler system; opening or closing a networked garage door; locking or unlocking a lock on a door, a cabinet door, etc.; telling a computer system to send an email, or a tweet via Twitter (possibly via a Web interface); and so forth.

### 4.2. Gesture Types

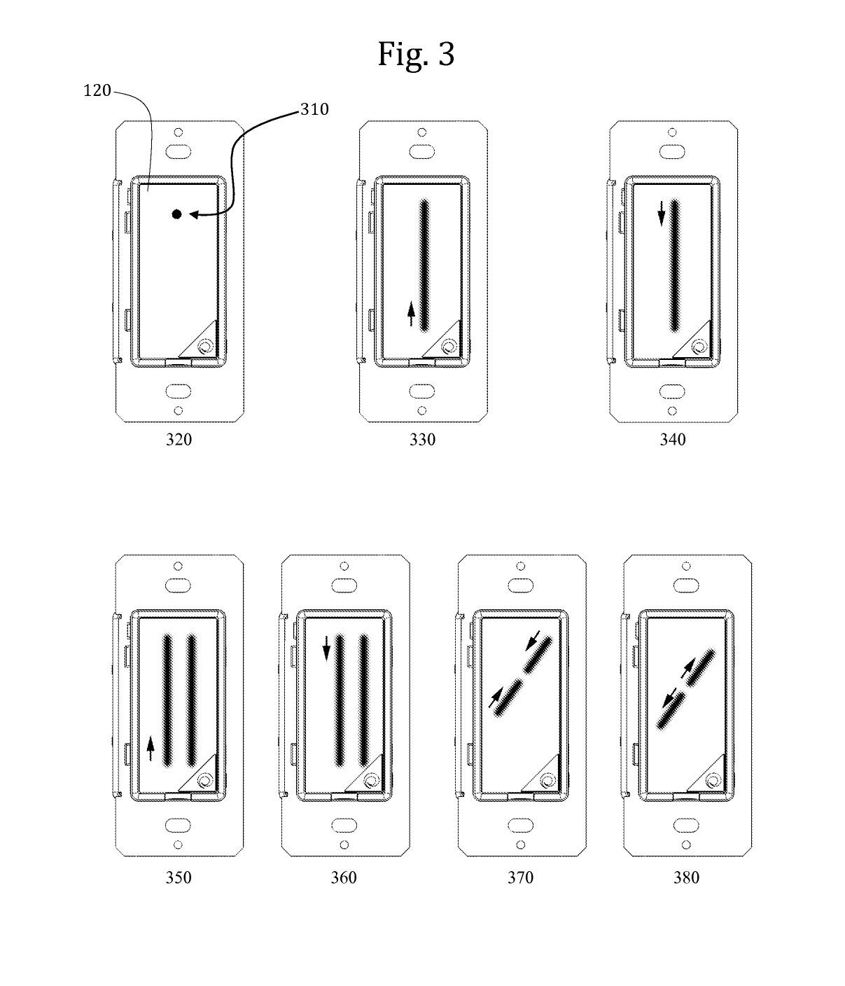

FIG. 3 shows some examples of representative gestures that can be made on the touch-input surface 220 to control a load or an network endpoint, with arrows showing the direction of each gesture. Gestures are made with one or multiple fingers, depending on the gesture.

As shown in illustrations 320 through 380, gestures made on the touch-input surface 220 can include but are not limited to: a single tap (or multiple taps on the same spot) 310 in illustration 320; a single swipe up in illustration 330; a single swipe down in illustration 340; double swipes up and down, respectively, in illustrations 350 and 360; a pinch gesture in illustration 360; and a zoom gesture in illustration 380.

Basic gestures with a single finger may be conveniently used to control a single device, while multi-finger basic gestures can control multiple devices. For example, a two-finger vertical swipe could control a room, while pinch and expand could control many devices in the house.

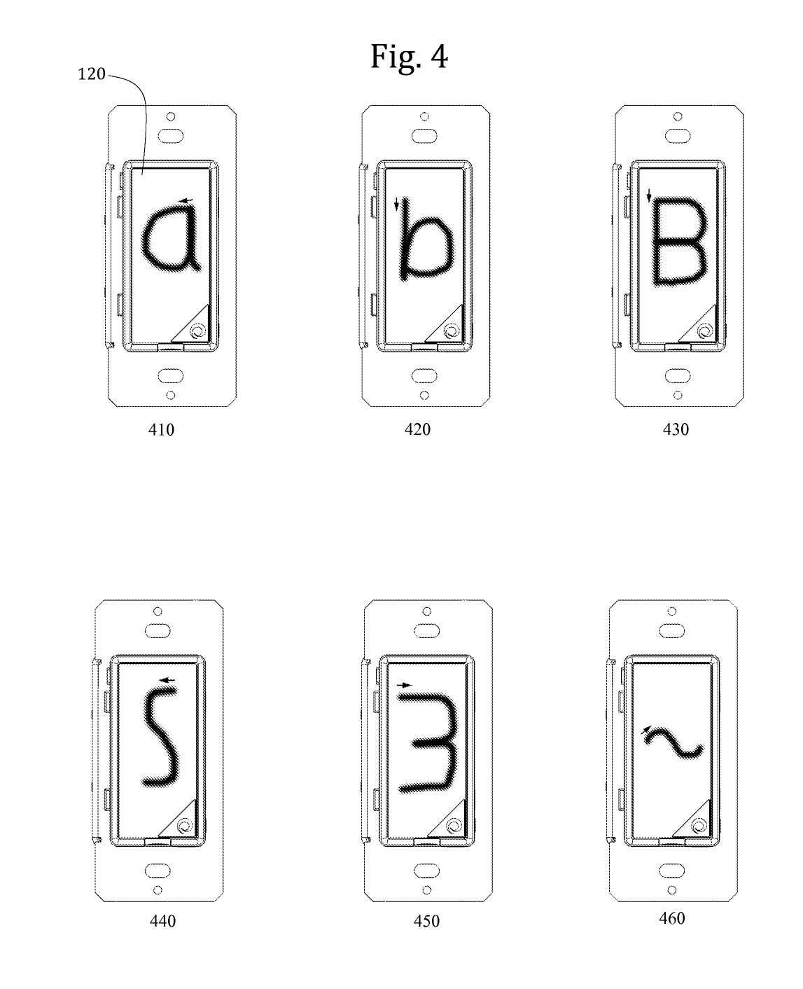

FIG. 4 shows examples of characters that can be traced on the touch-input surface 220 to cause activities to occur. traced characters, that is, are single-finger continuous strokes that can resemble lower- and upper-case letters (illustrations 410 through 440) as well as numbers (illustration 450), symbols such as a tilde (illustration 460) and other glyphs. As discussed below, the strokes could also be discontinuous, for example a capital T, but that would require the touch-control device 100 to perform additional processing to determine when a two-stroke entry was intended as a single gesture and when it was intended as multiple gestures.

Traced characters may be assigned to control some or all of specific local loads; individual network-based devices or other ENDPOINTS (including for example Web-based applications operating on remote servers); and groups of one or more of the foregoing. Such assignments can be based on configuration by the user; they can also be pre-configured in software. Traced characters can also be “learned” by the device, as discussed below.

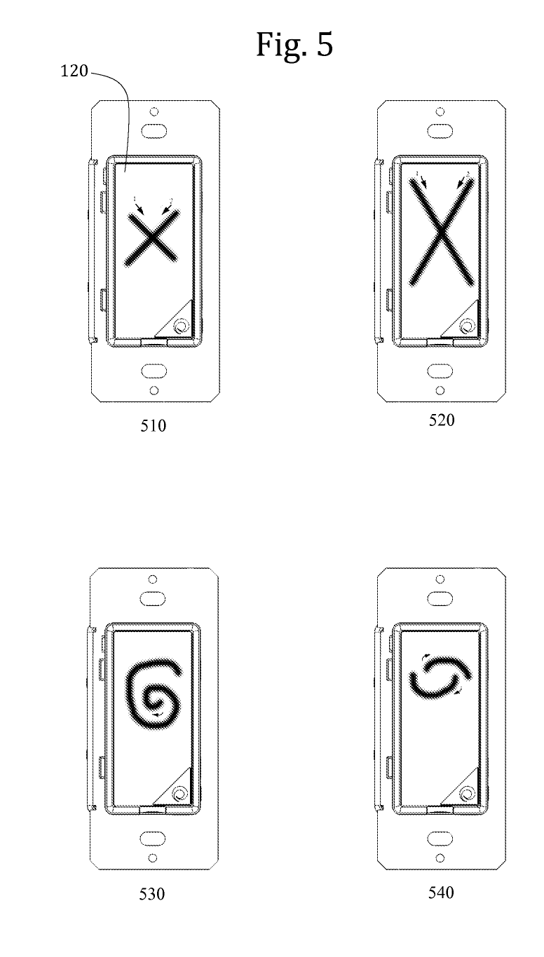

FIG. 5 shows additional gestures possible on the touch input panel 220. One or more multi-stroke characters, for example a lower-case “x” (illustration 510) or upper-case “X” (illustration 520) can be detected by the gesture processor as an individual gesture if the strokes occur within a short amount of time.

Additionally, the gesture processor gestures such as, for example, a lower-case “x” and upper-case “X” can be distinguished by relative size and can cause different actions to take place.

Single-finger custom gestures such as shown in illustration 530, along with multi-finger custom gestures such as shown in illustration 540, may resemble symbols or shapes, and like other types of gestures can be learned or pre-configured and used to trigger actions as discussed above.

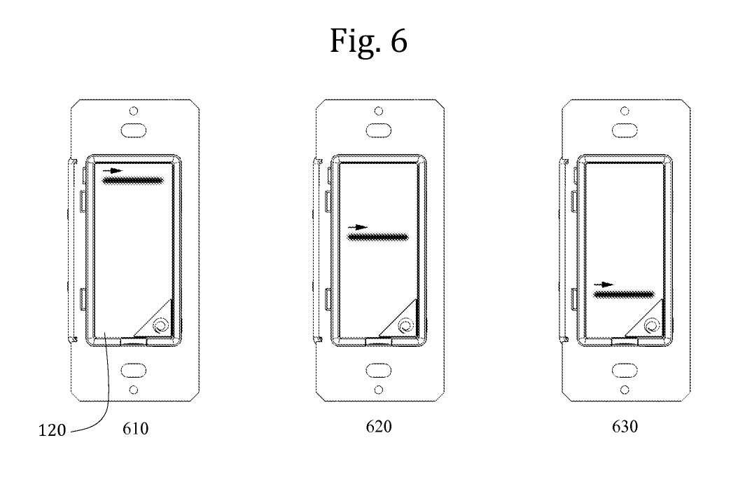

FIG. 6 shows a possibility for different actions to be triggered based on a single gesture based on the region of the touch-input surface 220 where the gesture is made. Horizontal swipe gestures located near the top ((illustration 610), near the middle (illustration 620), and the bottom (illustration 630) may be used to trigger different actions.

The ability of the touch-control device 100 to determine the specific location of a gesture on the touch-input surface 220 may be used to send a different set of commands to different endpoints 250 respectively networked on the same or a different network 245, or alternatively to a local load 235.

One embodiment of the invention includes using a single gesture on the touch-control device 100 to control a group of two or more devices simultaneously or in quick succession, for example one or more local loads, one or more endpoints, or some combination thereof.

For example, a single gesture might be used to simultaneously dim the lights in a living room and brighten the lights in the kitchen, or vice versa, or to turn off the lights in the living room and turn on the lights in a bedroom.

As before, the endpoint or endpoints in question could be on a local network or a wider-area network such as the Internet.

As another example, a gesture made on a touch-control device 100 at a home's entryway might turn on one or more bedroom lights via a local network 245 while setting a timer to turn off one or more entryway lights two minutes later.

It will be appreciated by those of ordinary skill having the benefit of this disclosure that a very large number of permutations and combinations can be utilized in this way.

The loads and/or endpoints that can be controlled in the manner described above can include but are not limited to: audio-video equipment, security systems, intelligent window treatments, home appliances, cameras, DVR's, gaming systems and other equipment. Additional services can include, but are not limited to: social media (Facebook, Twitter), emergency services (fire department, 911, etc.).

Specific gestures on the control device can start one or more respective chains of activities (scripts) that can control local loads and networked endpoints in the same general manner as described above. The scripts themselves can be stored at the touch-control device 100; at respective endpoints; or at other convenient locations, including “in the cloud.” The activities/scripts may include other elements including, but not limited to, internal timers, conditional statements, and queries.

The occurrence of multiple gestures in relatively-quick succession (for example, separated by approximately 20 seconds or less) may be interpreted by the touch-control device 100 as a prefix signal indicating the beginning of a command sequence. The commands of such a sequence may be organized in a tree-like menu structure, so that the user can navigate through an internal menu of the touch-control device.

A command sequence can also indicate that the touch-control device 100 is to send commands to specific loads 235 and/or endpoints 250; to send crucial information enclosed in a command (for example, state information); or to verify a gesturer's identity.

Specific sets of such multiple gestures can be processed by the controller module 230 as if the user were using a one-key keyboard to type, say, a sentence, one character at a time.

In some implementations, it may be desirable to have specific gestures mapped to different commands, based on the identity of the user. Gestures may be used, singly or in combination, to be used to identify a user and trigger actions based on that identification.

The touch-control device 100 can store, in a data store 255 or 260, lists of gestures and associated commands previously specified as being available for use by a specified user. For example, the parents of a household might be authorized to input commands to deactivate the house's security system, while young children in the household might not be so authorized. Conversely, if the control device 100 cannot identify the user as having sufficient access permissions, then the control device might permit only a limited subset of gestures to take effect, for example excluding those affecting the security system.

The touch-control device 100 might also reconfigure the lists of actions it takes in response to specific gestures, based on an identified user's preference (roughly analogous to some users preferring a Dvorak keyboard to a QWERTY keyboard).

User identification may be done automatically. For example, if the communication interface 240 is Bluetooth- or RFID-capable, then the controller module 230 may be conventionally programmed to pair the touch-control device 100 with a particular user's Bluetooth-capable cell phone or with an RFID device, perhaps embedded in a wallet card or similar item. When that user's cell phone or RFID device approaches the touch-control device 100, then the controller module 230, recognizing the cell phone or RFID device, may reconfigure its gesture recognition to a set of commands previously specified for that user, for example by the user configuring the command set. Preferably, the user may be required to confirm his or her identity by entering a password or personal identification number (PIN) code on the touch-input surface 220.

If desired, a visible signal can be displayed on the touch-control device 100 to alert the user that the control device is in a special mode such as menu-navigation mode. Such a visible signal could take the form of, for example, turning on a light such as a backlight (not shown), or changing a light's color or intensity, or changing the light's display pattern such as by flashing it.

A single gesture may be used as a prefix to indicate that the command represented by the next gesture is to be sent to a specific endpoint.

The use of multiple gestures can allow gestures after a command to append potentially needed information to the command for the system or non-local device to handle the signal. The additional information can include, but is not limited to, information relating to security codes, characters to increase or decrease a parameter (volume, temperature), symbols associated with audio-video equipment, numbers, letters, symbols, multi-touch gestures. For example, making a capital A on the touch-input surface 220 might indicate to the touch-control device 100 that a security system is to be armed, and that the next gesture(s) will be a security code needed to arm the system.

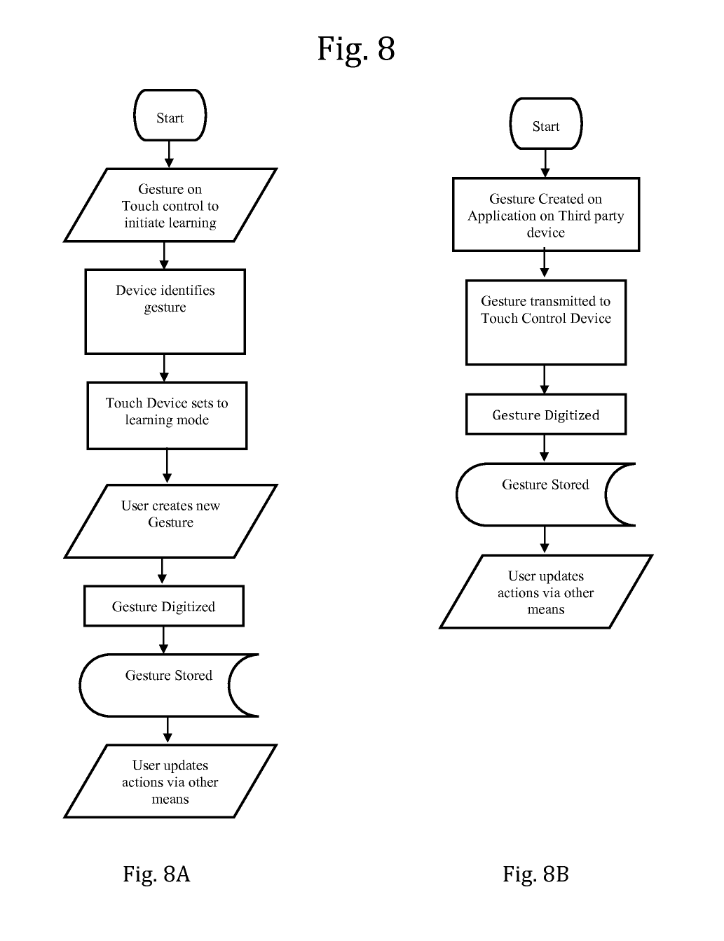

Referring to FIG. 8A and FIG. 8B, the touch-control device 100 may be programmed to learn new gestures. Methods for associating new gestures with specific actions can include, but are not limited to: using a third-party device such as a computer or smart phone (not shown) to upload new gesture-processing instructions to the touch-control device 100 activities via the communications interface 240, for example over a WiFi- or Bluetooth connection; storing such instructions via a series of gestures on the touch-input surface 220; and storing such instructions by modifying the states of one or more endpoints 250 controlled by the touch-control device 100, with the touch-control device detecting the state changes and responding accordingly. This final method can be stopped by gesture, by timeout, or when a certain number of endpoint devices are changed.

A specified gesture or series of gestures may be utilized to configure the touch-control device 100 and/or one or more endpoints. Such configuration can include, but is not limited to, resetting the control device or endpoint to its default state; connecting the control device to the network; searching for other endpoints to configure; and setting the network address (for example, an IP address, or a network identification number between 0 and 255) of the control device and/or the selected endpoint.

### 4.3. Alternatives

The above description of specific embodiments is not intended to limit the claims below. Those of ordinary skill having the benefit of this disclosure will recognize that modifications and variations are possible.

### 4.4. Glossary

COMMUNICATION INTERFACE (245) refers to an interface allowing two-way communication between the touch-control device 100 (specifically, the controller module 230) and the NETWORK 240.

ENDPOINT (250) refers to a device or service with which a user or consumer directly interfaces and has direct utility for the user. Examples include light fixtures; thermostats; security cameras; security panels; door locks; telephones; televisions; digital video recorders and other TV set-top boxes; sprinkler control systems; pool- and Jacuzzi control; audio systems such as music systems; slow cookers; and the like. An endpoint could also be an external service such as an application running on a desktop or on a Web-based server; for example an endpoint could be Twitter's servers. An endpoint could also be an application running on a mobile device such as an iPhone app.

GESTURE refers to a series of one or more contacts made upon the touch-input surface 220. Each contact is made using one, two, or more fingers, or alternatively with one or more styluses or similar devices (or a combination of one or more fingers and one or more styluses), either in direct contact with or in close proximity to the touch-input surface 220. A gesture can be, for example, a single tap; a multi-tap, that is, two or more taps in comparatively-quick succession; a swipe in various directions, e.g., up, down, across, or diagonally; a pinch; a zoom; or a tracing motion, referred to as a trace.

LOAD CONTROLLER (232): See the discussion above.

NETWORK (240) refers to a packet-based communications network such as wired networks (including dedicated wires; network wiring such as Cat-5 or Cat-6 using, for example, an Ethernet network; and/or power lines); wireless networks (including for example the well-known WiFi in various flavors, Bluetooth, Zigbee, ZWave, and/or one or more proprietary radio-frequency [RF] channels); or a combination of both wired- and wireless networks.

1. A touch-control device comprising the following:
(a) the touch-control device includes (1) a touch-input surface capable of detecting gestures made in two dimensions; (2) a gesture processor; (3) a controller module; (4) at least one DATA STORE; and (5) one or more LOAD CONTROLLERs connectable to control the applicable of electrical power to one or more loads;
(b) the gesture processor is operatively coupled to the touch-input surface to generate one or more respective digital signals, each referred to as a gesture signal, representing each of one or more such gestures;
(c) the controller module is operatively coupled to receive gesture signals from the gesture processor;
(d) the controller module is operatively coupled to the at least one data store to search for an identifier of a specific gesture corresponding to the gesture signal;
(e) the controller module is operatively coupled to the one or more load controllers to generate one or more load-control signals corresponding to the gesture identifier; and
(f) the touch-control device is configured to fit in a standard electrical wall box.

2. The touch-control device of claim 1, in which:
(1) the controller module further includes a COMMUNICATION INTERFACE configured to be operatively coupled to the controller module and to a NETWORK; and
(2) the controller module is programmed to send at least one ENDPOINT-control signal, corresponding to the gesture identifier, to the network via the communication interface.

3. The touch-control device of claim 2, wherein the controller module is programmed to generate at least one ENDPOINT-control signal whose information conforms to a format understandable by a Web-based application operating on a remote server.

4. The touch-control device of claim 2, in which the controller module is programmed to communicate with at least one of the at least one data store via the communication interface and the network.

5. The touch-control device of claim 1, in which the controller module is programmed to recognize a specified gesture as a prefix signal.

6. The touch-control device of claim 1, wherein the controller module's responses to gestures are user-configurable.

7. The touch-control device of claim 1, in which one or more specified command sequences is available only to one or more specified users.

8. The touch-control device of claim 1, wherein different gesture identifiers are stored in the one or more data stores as corresponding to a specified gesture, depending on the region of the touch-input surface where the gesture is made.

9. The touch-control device of claim 2, wherein the controller module is programmed to generate respective control signals for at least two types of ENDPOINT.

10. The touch-control device of claim 2, wherein the controller module is programmed to generate, in response to a single gesture, respective control signals for (1) an ENDPOINT, and (2) one or more of (i) the load; and (ii) another ENDPOINT.

11. The touch-control device of claim 1, in which the touch-input surface and the gesture processor are operatively coupled to detect multi-touch gestures.

12. A home control system comprising:
(a) a touch-control system in accordance with claim 2; and
(b) at least one endpoint controllable by the touch-control system.

13. The home control system of claim 12, wherein at least one endpoint includes an electrical outlet controllable by the touch-control device.

14. The home control system of claim 12, wherein at least one endpoint includes a lighting fixture controllable by the touch-control device.

15. The home control system of claim 12, wherein at least one endpoint includes a lighting fixture controllable by the touch-control device.

16. The home control system of claim 12, wherein at least one endpoint includes a home-security device controllable by the touch-control device.
